(19) United States
(12) Patent Application Publication
(10) Pub. No.: US 2001/0043974 A1
(43) Pub. Date: Nov. 22, 2001

(54) Method and apparatus for making flame-grilled patties

(76) Inventors: James W. Linford, Eagle, ID (US); Jan P. Smith, Ogden, UT (US); Michael M. Roberts, Ogden, UT (US); Sarah Z. Masoni, St. Helens, OR (US); Diane M. Zielinsky, Pleasant View, UT (US)

Correspondence Address: MILLER NASH LLP, ATTN: KAREN DANA OSTER, 111 S.W. FIFTH AVENUE, SUITE 3500, PORTLAND, OR, 97204-3699, US

(21) Appl. No.: 09/859,342

(22) Filed: May 16, 2001

Related U.S. Application Data
(60) Provisional application No. 60/205,792, filed on May 17, 2000.

(51) Int. Cl. A23B 4/00

(52) U.S. Cl. 426/302; 426/523; 99/430

(57) ABSTRACT

A method for flame-grilling patties, including the steps of cooking the patties, coating the patties, and branding the patties. The invention also includes apparatus for performing the method.

The present application is based on and claims priority from provisional application serial No. 60/205,792, filed May 17, 2000.

### BACKGROUND OF THE INVENTION

The present invention is directed to a method and apparatus for making flame-grilled patties. Specifically, in one preferred embodiment of the present invention the process of igniting a vegetarian or soy patty produces a taste unique in the industry.

Vegetable (veggie) and soy patties (meatless burgers) have become a staple in vegetarian diets. Nonvegetarians (or carnivores) also enjoy the health benefits of veggie and soy patties. In the past, these patties have been prepared and sold by processes that substantially include the following steps: receiving ingredients; scaling and preparing the ingredients; providing feed stations with the ingredients; mixing the ingredients; grinding the ingredients; forming the ingredients into patties; cooking the patties; cooling the patties; freezing the patties; packaging the patties; and storing and distributing the packages.

Gardenburger, Inc., the assignee of the present invention, has been producing a broad range of healthy, great-tasting, and convenient meat-free for more than 15 years. Gardenburger is considered to be a leading manufacturer and distributor of meatless burgers in the United States. The Gardenburger product line, featuring the veggie grain-based Original Gardenburger®, is a top national meatless burger brand in market share in the retail grocery, food service, club store, and natural foods channels of distribution. In the retail grocery channel, Gardenburger distributes to approximately 25,000 grocery stores and had a unit market share of 34 percent for the 52 weeks ending Apr. 7, 2001. Gardenburger also distributes its products to approximately 35,000 food service outlets, 600 club store locations, and 4,000 natural food stores. In the category of meatless patties, Gardenburger has consistently led trends in the marketplace. For example, Gardenburger introduced gourmet-flavored meatless patties that were later imitated by other others in the industry.

During its 15-year history, Gardenburger has continuously developed and introduced products including GARDENVEGAN® patties, HAMBURGER STYLE SAUTEED ONION™ patties, HAMBURGER STYLE ROASTED GARLIC™ patties, GARDENBURGER HAMBURGER STYLE® Classic patties, GARDENBURGER ORIGINAL™ patties, CLASSIC GREEK GARDENBURGER® patties, GARDENBURGER SANTA FE® patties, GARDENBURGER SAVORY MUSHROOM® patties, FIRE ROASTED VEGETABLE GARDENBURGER® patties, TAYBURN® Smoked Cheddar patties, GARDENBURGER VEGGIE MEDLEY® patties, LIFEBURGER® patties, GARDENSAUSAGE® patties, GARDENBURGER HAMBURGER CLASSIC® patties, HAMBURGER CLASSIC INSTITUTIONAL™ patties, GARDENBURGER VEGGIE VEGAN® patties, SYSCO® Imperial Veggie Patty Vegan patties, SYSCO® Gourmet Style patties, SYSCO® Imperial Veggie Patty Original patties, SYSCO® Imperial Veggie Patty Ranchero patties, SYSCO® Imperial Veggie Patty Hamburger, GARDENBURGER SUBWAY PATTY™ patties. All of these products are precooked.

Boca Burger, Inc. produces meat substitute products such as the ORIGINAL BOCA BURGER®, a vegan patty. The ORIGINAL BOCA BURGER® includes nonmeat ingredients, such as soy protein concentrate, spices, and vegetable fiber. After the ingredients are scaled and mixed, they are formed into patties. The patties are then thermally processed or baked. The precooked patties are then frozen and packaged.

MORNINGSTAR FARMS® GRILLERS™ are a blend of vegetable and grain protein ingredients that are scaled, mixed, and formed into patties. The patties are thermally processed or baked and then flash-fried. The precooked patties are then frozen and packaged. The flash-flying of the GRILLERS™ modifies the flavor, mouth-feel, and consumer appeal.

MORNINGSTAR FARMS® Garden Veggie Patties are a blend of textured vegetable protein and grain veggie products that are scaled, mixed, and formed into patties. The patties are thermally processed or baked. The cooked patties are then flash-fried in corn oil and the excess oil is removed using air, a knife, or a brush. The resulting patties are then frozen and packaged. The flash-frying of the Garden Veggie Patties modifies the flavor, mouth-feel, and consumer appeal.

Grilling or branding meat such as fish fillets, meat patties, and chicken breasts is also well known in the industry. Branding is used to create a grill mark on the surface meat, such as hamburger patties, chicken breasts, or fish fillets. A branding machine places a hot metal brand onto the surface of the meat. This causes the patties to be visibly grilled.

One example of a meat patty that is grilled is the BURGER KING® WHOPPER®. The WHOPPER® is made by grinding and mixing the meat ingredients, forming the patties, freezing the uncooked patties, and packaging the frozen patties. At the time the meat is to be cooked, the frozen raw beef patties are cooked in a NIECO® broiler. In the NIECO® broiler, fat and water in the beef patty melt and drip down onto the open flames, creating smoke and excessive heat. The heat sears the beef on the chain that carries the meat through the broiler and leaves a branded mark as well as the “char broiled” flavor characteristic of the BURGER KING® WHOPPER®. The cooked Whopper is marked on only one side of the beef patty. Further, there is about 30 percent moisture loss or shrinkage in this cooking process.

U.S. Pat. No. 4,297,942 to Benson et al. is directed to a method and apparatus for flavoring and surface treatment of meat products. Specifically, the Benson process imparts a charcoal-broiled flavor and appearance to meat products, moves the product into contact with open gas flames to sear the product's surfaces, and brands the upper and lower product surfaces with hot metal branding elements. As the title suggests, the entire disclosure is directed to an apparatus specifically for grilling meat patties such as “steaks, chops, or hamburger patties.” The Benson process relies on the oils found in the meat patties for the searing process.

### BRIEF SUMMARY OF THE INVENTION

The present invention is directed to a new method of making flame-grilled patties. The invention modifies known cooking procedures for nonmeat patties and adds the steps of coating/flavoring and grilling (or flame-branding). The invention also modifies known grilling procedures for meat patties and adds the step of coating/flavoring that is not necessary for meat products. In one preferred embodiment the flame-grilled patties are veggie or soy patties that have been flame-branded so that they have a unique texture and/or appearance.

The present invention is also directed to an apparatus that has been specifically constructed to withstand the flame-grilling of the aforementioned method.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWING

FIG. 1 is a flow chart depicting one preferred embodiment of the method for making flame-grilled patties of the present invention.

FIG. 2 is a flow chart detailing the cooking step, the flavoring step, and the grilling step of the present invention.

FIGS. 3A-3C are side views of an exemplary set of machines, including a steam chamber, oven boxes, a butter machine, and a brander.

FIG. 4 is a detailed view of the batter machine, showing the coating and blowing apparatus.

FIG. 5 is a detailed perspective view of the brander.

FIG. 6 is a cross-sectional view of the brander taken along line 6-6 of FIG. 5.

### DETAILED DESCRIPTION OF THE INVENTION

The present invention is directed generally to a method for making flame-grilled patties and in particular to making flame-grilled veggie patties and flame-grilled soy patties. Alternate embodiments may include a method for making flame-grilled meat patties or a method for making flame-grilled fish patties (raw or cooked).

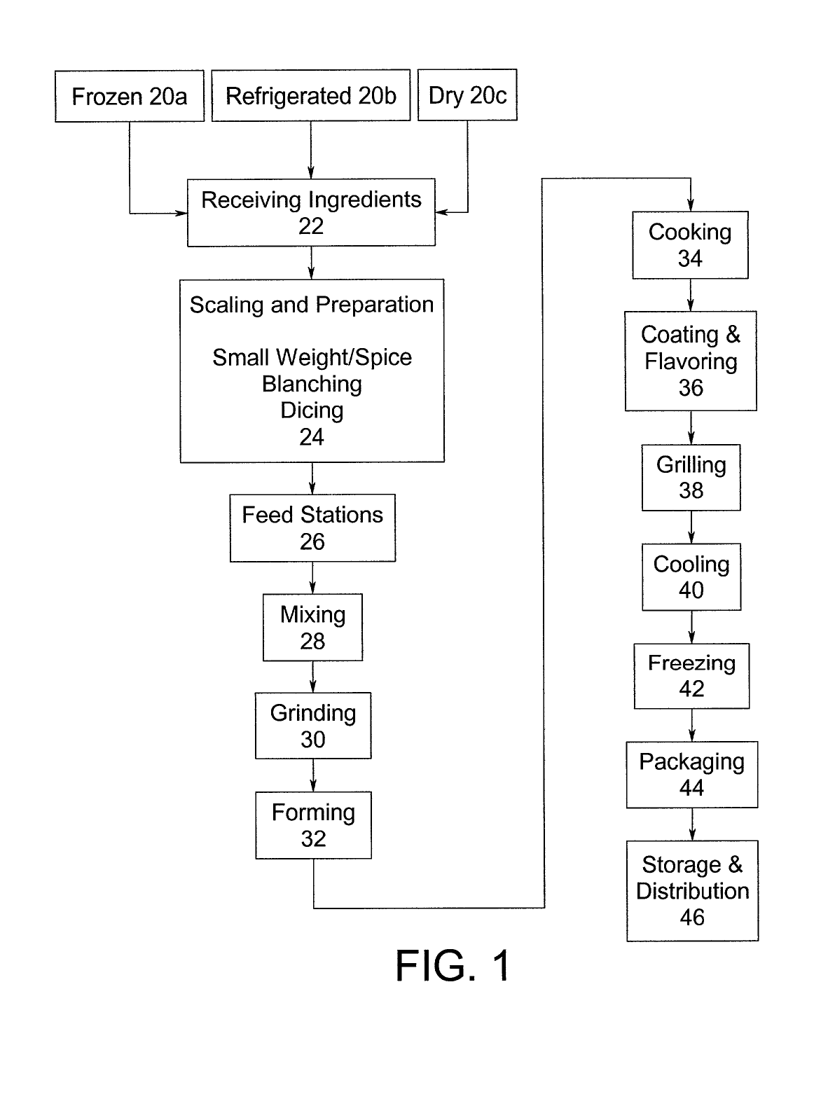

FIG. 1 shows one preferred embodiment of the present invention. As set forth herein, this embodiment is meant to be exemplary, and alternatives are included in the scope of the invention.

The first step of the process includes receiving frozen ingredients 20a, refrigerated ingredients 20b, and/or dry ingredients 20c at a receiving station 22. An exemplary list of ingredients for a veggie patty might include: mushrooms, cooked brown rice, onions, mozzarella cheese ([pasteurized milk, cultures, salt, enzymes], nonfat milk, corn starch, natural flavors, annatto [vegetable color]), rolled oats, bulgur wheat hydrated, cottage cheese curd (nonfat milk, culture, enzymes), vegetable oil (canola and/or sunflower oil), salt, vegetable gum, wheat gluten, dried garlic, autolyzed yeast extract, spices, natural flavors, citric acid, natural grill flavor (from vegetable oil), natural butter flavor, annatto (vegetable color), dried yeast, dried onion, soy sauce (wheat, soybeans, salt), cheddar cheese (milk, cheese cultures, salt, enzymes), dextrose, whey, dried mushrooms, sesame oil, ascorbic acid, dried cream cheese (cultured pasteurized milk, salt, carob bean gum), torula yeast, reduced lactose whey, dried cultured buttermilk, lactic acid, and cultured whey. An exemplary list of ingredients for a soy patty might include: soy protein, concentrate-hydrated, vegetable oil (canola and/or sunflower oil), vegetable gum, autolyzed yeast extract, wheat gluten, natural flavor, salt, dried onion, caramel color, natural grill flavor (from vegetable oil), dried garlic, chicory root extract, spice, dried yeast, soy sauce (wheat, soybeans, salt), sesame oil, and ascorbic acid. These ingredients are meant to be exemplary.

On demand, the received ingredients 22 are scaled and prepared. For example, ingredients that require only small weights, such as spices, may be scaled. Heavier ingredients may be blanched or diced. This scaling and preparation step is shown generically as a scaling and preparation step 24.

The scaled and prepared ingredients are then conveyed to feed stations 26. The feed stations 26 may be, for example, large hoppers with augers in the bottom. In one preferred embodiment, these feed stations are custom-designed and built; alternative feed stations may be used. These feed stations drop ingredients onto a conveyor belt that conveys the ingredients through mixing stations where the ingredients may be mixed 28, grinding stations where the ingredients may be ground 30, and/or forming stations where the ingredients may be formed into a desired shape 32. In one preferred embodiment a Koppens forming machine is used to form patties. Depending on the product being prepared, these steps may be optional. For example if the ingredients are relatively small, or if a more granular consistency is desired, the grinding step may be omitted. Further, if preprepared and formed products are provided, all the aforementioned steps are unnecessary.

The formed patties are then cooked 34, coated and flavored 36, and grilled 38. The cooking 34, coating and flavoring 36, and grilling 38 form the heart of the present invention and are discussed in detail below.

The prepared and cooked patties are then cooled 40, frozen 42, packaged 44, and stored and/or distributed 46. Cooling, freezing, packaging, and storage and distribution are well known in the industry. It should also be noted that patties prepared according the present invention could be used prior to or without these steps. For example, the present invention would include patties prepared using the present invention and then served fresh in a restaurant.

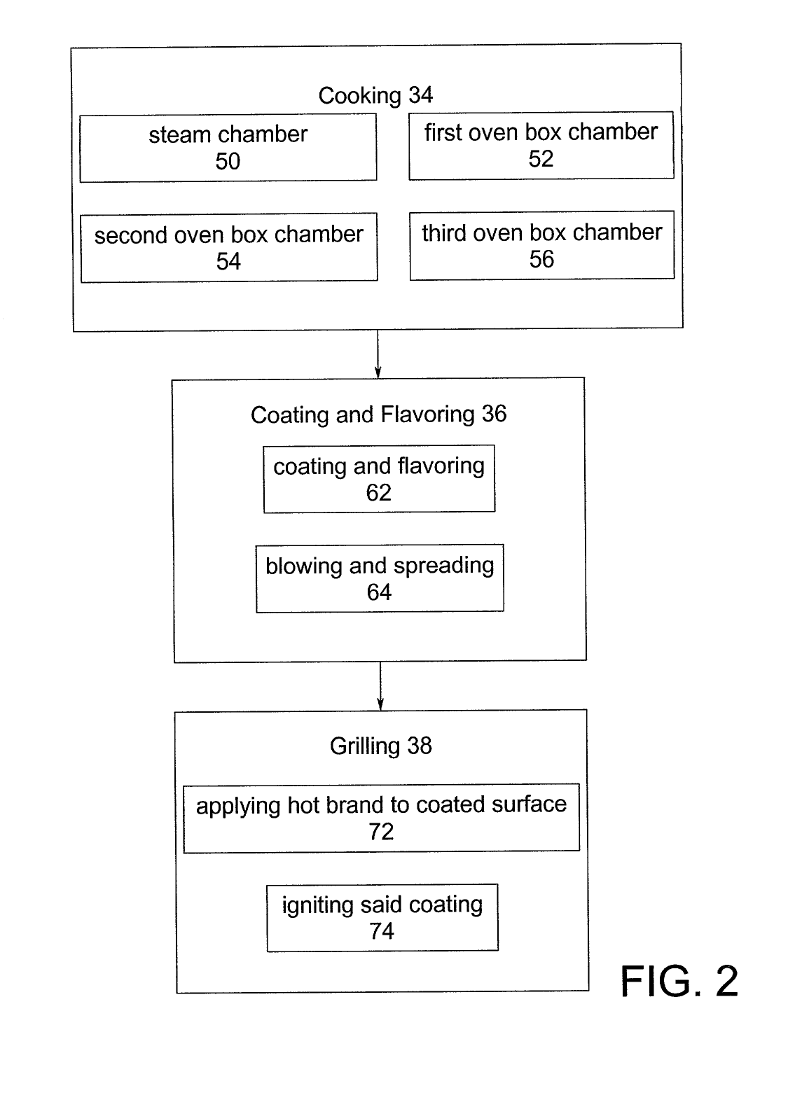

FIG. 2 shows one preferred embodiment of the cooking 34, coating and flavoring 36, and grilling 38 steps of the present invention.

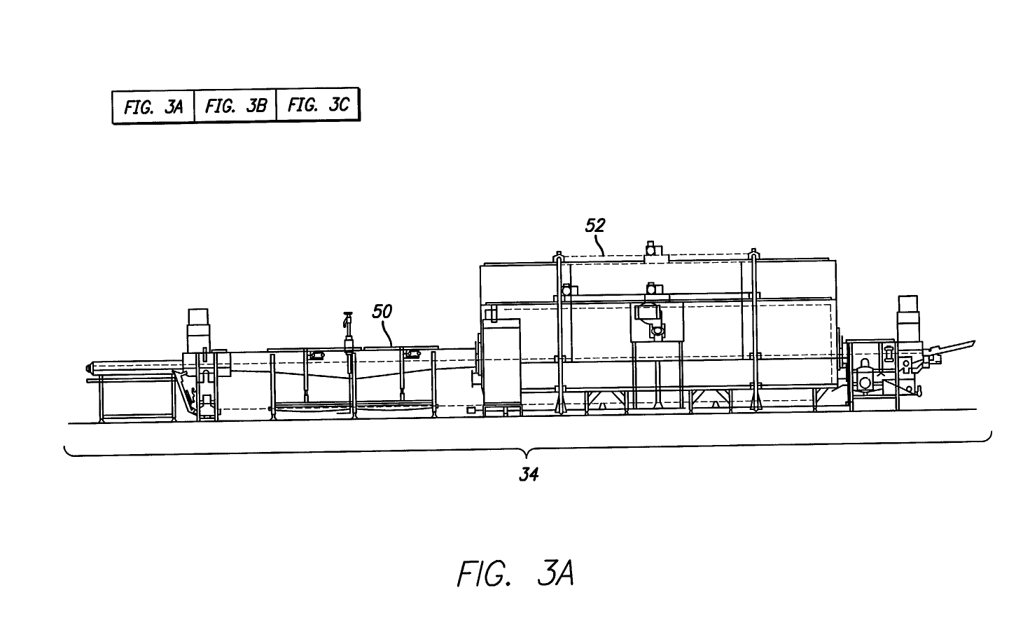

The cooking 34 in the shown preferred embodiment takes place in four separate chambers: a steam chamber 50 (FIG. 3A), a first oven box chamber 52 (FIG. 3A), a second oven box chamber 54 (FIG. 3B), and a third oven box chamber 56 (FIG. 3B). Each of these chambers uses a combination of steam and heat to cook the patties. For example, with veggie patties, one preferred embodiment of the invention would use 100 percent steam in the steam chamber 50, 100 percent steam and 250 degrees heat in the first oven box chamber 52, 65, percent steam and heat at 375 degrees in the second oven box chamber 54, and 35 percent steam and heat at 300 degrees in the third oven box chamber 56. For soy patties, one preferred embodiment of the invention would use 100 percent steam in the steam chamber 50, 100 percent steam and 350 degrees heat in the first oven box chamber 52, 100 percent steam and heat at 160 degrees in the second oven box chamber 54, and no steam and heat at 50 degrees in the third oven box chamber 56. The percentages and temperatures are meant to be exemplary and are not meant to limit the scope of the invention. Prior to the present invention, no steam was used in cooking the soy or veggie patties, and only three chambers were used. Standard cooking stations produced by such companies as Koppens and Stein may be used or, alternatively, custom cooking stations may be built.

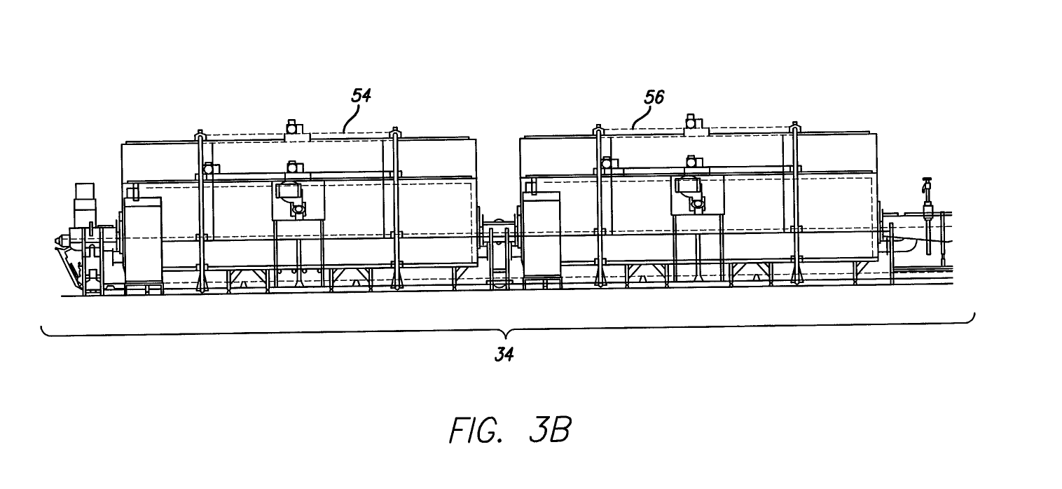

It should be noted that the cooking process and apparatus described above are meant to be exemplary. Alternate embodiments could include cooking by steaming alone, cooking using one or more oven box chambers, or alternative cooking methods. The highly automated shown embodiment is also meant to be exemplary because the cooking may be done manually. Precooked patties could also be used. Using a “batter machine” 60 (FIG. 36 and shown in detail in FIG. 4), the coating and flavoring step 36 of FIG. 2 first coats 62 the previously cooked patties with a proprietary oil-based flavoring product. Preferably, the coating is then at least partially blown off 64 the patties so that they are evenly coated. The batter machine 60 produced by Koppens that may be used accomplishes the coating and flavoring step 36. In alternate embodiments, the coating and flavoring 36 may be performed manually or by alternate mechanized means, such as by dipping the previously cooked patties into the flavoring product.

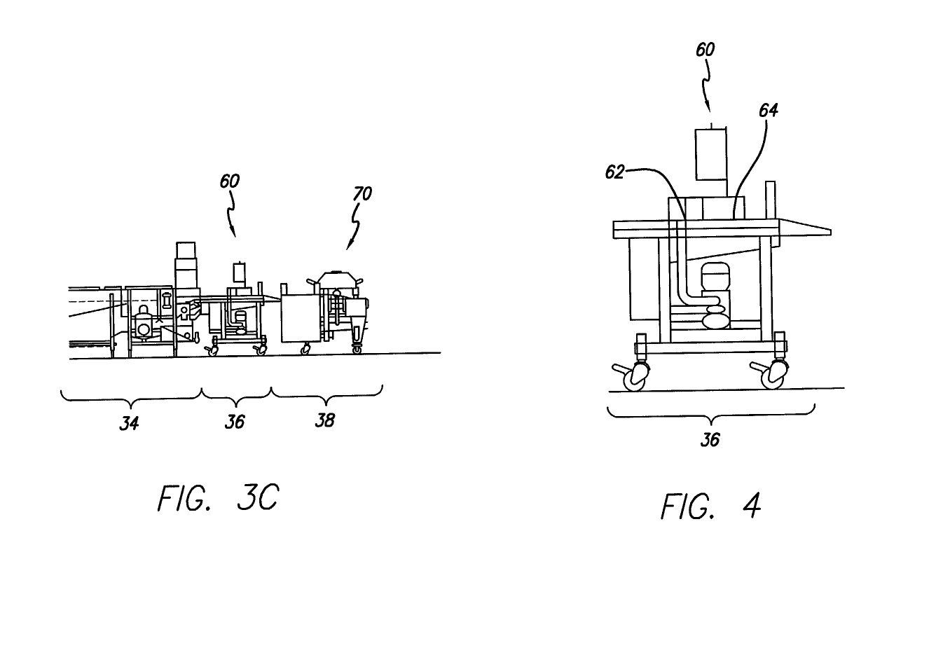

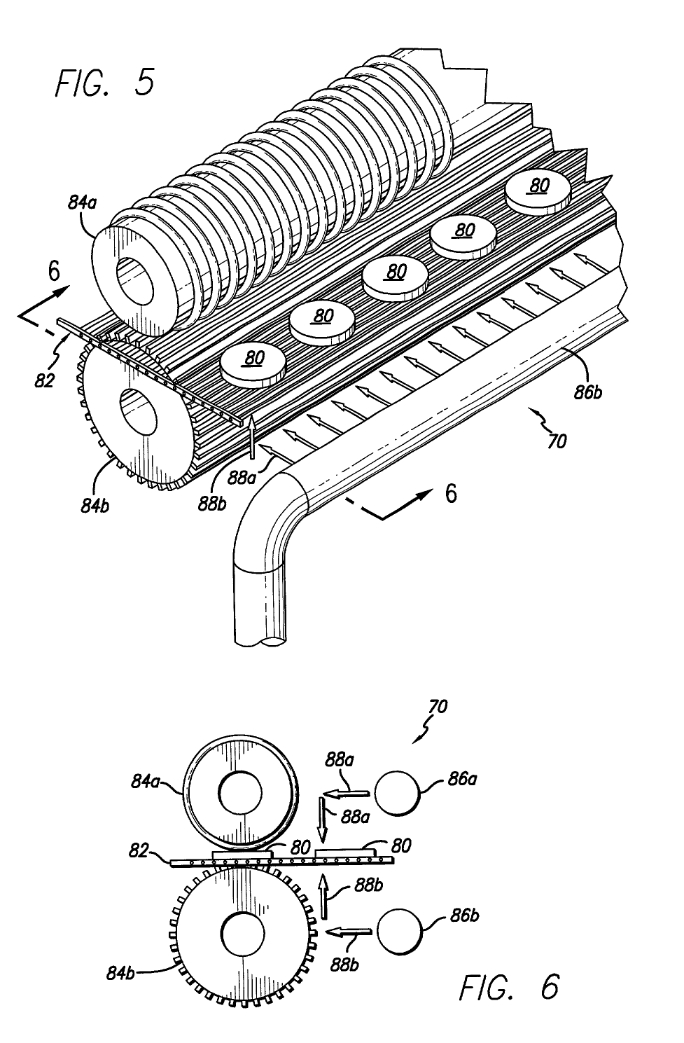

In the grilling or branding step 38 of FIG. 2, a brander 70 (FIG. 3. and shown in detail in FIGS. 5 and 6) places a hot brand onto the coated surface of the patties 72. The hot brand causes the coating to ignite and flame 74. One preferred embodiment of the brander 70 is shown in FIGS. 5 and 6. In this embodiment, patties 80 move on a conveyor system 82 between upper and lower brander wheels 84a, 84b. Upper and lower burners 86a, 86b provide flames 88a, 88b that both heats the brander wheels 84a, 84b and helps heat the patties 80. As the patties 80 move along the conveyor system 82, the heated brander wheels 84a, 84b come into contact with the coated surface of the patties 80. Alternately, the brander wheels 84a, 84b come sufficiently close to or in contact with the coated surface of the patties 80 to ignite the coating. The ignited coating flames, and it is this flame that adds a significant flavor to the patties. Because there is no one else in the industry who is using this combination of coating and branding, this flaming is completely novel.

Standard branders, although they will work in the aforementioned branding process, have significant problems. For example, the addition of flames has shown that the standard metal is not sufficient for this process. Accordingly, in the preferred embodiment of the invention, a customized brander is used, which is constructed at least partially from alloy metals designed to withstand operating temperatures in excess of 1600° F. Further, heat shields in the customized brander have also been converted to this alloy metal. The customized brander also includes extensive heat-shielding, infrared temperature controls, and an extensive safety system to ensure safe operation for extended periods. The customized brander exhausts gases through an array of exhaust passages to optimize brander temperature and maximize brander efficiency. In an alternate preferred embodiment of the brander, a standard brander may be used that has been modified to include one or more of the aforementioned features of the customized brander.

Although the present invention is directed primarily to nonmeat patties, alternate embodiments can be contemplated in which meat, poultry, or fish patties are used in place of the nonmeat patties described herein.

The terms and expressions that have been employed in the foregoing specification are used as terms of description, not of limitation, and are not intended to exclude equivalents of the features shown and described or portions of them. The scope of the invention is defined and limited only by the claims that follow.

What is claimed is:

1. A method for flame-grilling patties, said method comprising the steps of:
(a) cooking at least one patty to form at least one cooked patty;
(b) coating at least one surface of said at least one cooked patty with a coating; and
(c) branding said at least one coated surface of said at least one patty.

2. The method of claim 1, wherein said cooking step is a multilevel cooking process.

3. The method of claim 1, wherein said cooking step includes the step of applying steam to cook said at least one patty.

4. The method of claim 1, wherein said coating step includes the step of applying a flammable oil.

5. The method of claim 1, wherein said coating step includes the step of applying a flavoring agent.

6. The method of claim 1, wherein said coating step includes the step of evenly distributing said coating.

7. The method of claim 1, wherein said coating step includes the step of blowing said coating.

8. The method of claim 1, wherein said branding step includes the step of applying a hot brand to said at least one surface of said at least one patty.

9. The method of claim 1, said branding step further comprising the steps of:
(a) heating a first brander wheel;
(b) heating a second brander wheel;
(c) conveying said at least one cooked patty between said first brander wheel and said second brander wheel;
(d) igniting a first coated surface of said at least one cooked patty with said first brander wheel; and
(e) igniting a second coated surface of said at least one cooked patty with said second brander wheel.

10. The method of claim 1, wherein said branding step includes the step of igniting said at least one coated surface of said at least one patty.

11. The method of claim 1 wherein said step of cooking at least one patty to form at least one cooked patty further comprises a step selected from the group consisting of:
(a) cooking at least one veggie patty to form at least one cooked patty;
(b) cooking at least one soy patty to form at least one cooked patty;
(c) cooking at least one meatless patty to form at least one cooked patty;
(d) cooking at least one meat patty to form at least one cooked patty;
(e) cooking at least one poultry patty to form at least one cooked patty; and
(f) cooking at least one fish patty to form at least one cooked patty.

12. A method for flame-grilling patties, said method comprising the steps of:
(a) providing a patty;
(b) coating at least one surface of a patty with an oil-based coating; and
(c) branding said at least one coated surface of said patty, thereby igniting said oil-based coating.

13. The method of claim 12 wherein said step of providing a patty further comprises a step selected from the group consisting of
(a) providing a veggie patty;
(b) providing a soy patty;
(c) providing a meatless patty;
(d) providing a meat patty;
(e) providing a poultry patty; and
(f) providing a fish patty.

14. The method of claim 12, further comprising the step of cooking said patty.

15. An apparatus for flame-grilling patties, comprising:
(a) means for cooking at least one patty to form at least one cooked patty;
(b) a batter machine for coating at least one surface of said at least one cooked patty with an oil-based coating; and
(c) a brander for branding said at least one coated surface of said at least one patty.

16. The apparatus of claim 15 wherein said means for cooking is a multilevel cooking process.

17. The apparatus of claim 15, wherein said means for cooking includes a steamer.

18. The apparatus of claim 15, wherein oil-based coating is a flammable oil.

19. The apparatus of claim 15, wherein said oil-based coating is a flavoring agent.

20. The apparatus of claim 15, said brander further comprising:
(a) a first brander wheel;
(b) a second brander wheel;
(c) at least one meatless patty;
(d) a conveyor on which said at least one cooked patty travels between said first brander wheel and said second brander wheel;
(e) said first brander wheel for igniting a first coated surface of said at least one cooked patty; and
(f) said second brander wheel for igniting a second coated surface of said at least one cooked patty.

21. The apparatus of claim 15, wherein said brander includes means for igniting said at least one coated surface of said at least one patty.

22. The apparatus of claim 15 wherein at least one patty is selected from the group consisting of:
(a) at least one veggie patty;
(b) at least one soy patty;
(c) at least one meatless patty;
(d) at least one meat patty;
(e) at least one poultry patty; and
(f) at least one fish patty.
